(19) United States
(12) Patent Application Publication
(10) Pub. No.: US 2018/0209178 A1
(43) Pub. Date: Jul. 26, 2018

(54) A Detachment Unit for Removing a Tag

(71) Applicant: ITAB SHOP PRODUCTS AB, Jönköping (SE)

(72) Inventors: Peter Wärnbring, Bankeryd (SE); Niklas Thoresson, Källö-Knippla (SE); Mujo Redzovic, Huskvarna (SE)

(21) Appl. No.: 15/746,127

(22) PCT Filed: Jul. 8, 2016
(86) PCT No.: PCT/EP2016/066228

§ 371 Date: Jan. 19, 2018

(30) Foreign Application Priority Data
Jul. 21, 2015 (SE) 1551034-0

(51) Int. Cl. E05B 73/00; G06Q 20/20

(52) U.S. Cl. CPC E05B 73/0064; G06Q 20/203

(57) ABSTRACT

A detachment unit for removing a tag from an article comprising an operating member comprising a first extractor, and a second extractor arranged at a distance from said operating member such that the tag can be positioned between the first extractor and the second extractor. The operating member is movable such that the first extractor moves towards and away from the second extractor so that when the first extractor is in proximity to the tag the first and the second extractor can be activated for detaching the tag from the article, wherein the operating member comprises a collector for automatically collecting at least one part of the detached tag.

### TECHNICAL FIELD

The present invention relates to a system for removing security tags arranged on articles as well as to an automated checkout counter comprising such system.

### BACKGROUND

In today's stores many different articles, such as food products, hygiene articles, clothing, textures, etc. may be purchased which all have different sizes and shapes. Normally, a checkout operator handles each article manually and makes sure that the article is associated with the correct pricing at checkout for payment by the customer. This is traditionally done either by manually inputting the price, by scanning a barcode attached to the article, or a combination of those. However, automatic checkout counters are becoming an interesting alternative for retail stores and supermarkets. Such checkout counters provides safe and easy handling of articles and they normally include different components for identifying the article accurately.

In order to prevent and/or detect customer from taking articles outside the store without paying for the item, some articles may be part of a surveillance system. The surveillance system may include a security tag that is removable attached to the article, such that an unauthorized removal may activate an alarm (either visual or audible). The alarm of the security tag may also be activated if a customer tries to take the article outside of the store without having the security tag deactivated and/or removed. Normally, a checkout operator handles each article manually and deactivates and/or removes the security tag prior or after the payment process.

Having to have a checkout operator to manually deactivate and/or remove the security tag from an article has several drawbacks. Firstly, the security tag may be very difficult to remove from an article and there is a risk that the article gets damaged during the process. Secondly, it may require some amount of force to separate the tag from the article which makes it unsuitable for some costumers, e.g. the elderly, handicapped or children. Furthermore, if the security tag is comprised by a sharp pin, which often is the case in the so called hard tags, there is the hazard of being exposed to the sharp end while removing the tag from the article.

An important aspect of automatic checkout counters is to be able to automatically remove security tags from an article. Therefore, there is a need for a system for safely removing security tags, especially when such system is used in automatic checkout counters.

### SUMMARY

An object of the present invention is to provide a system for removing security tags on articles in a conveyor system for a checkout counter which is improved over prior art.

According to a first aspect, a detachment unit for removing a tag from an article is provided. The detachment unit comprises an operating member comprising a first extractor and a second extractor arranged at a distance from said operating member such that the tag can be positioned between the first extractor and the second extractor. The operating member is movable such that the first extractor moves towards and away from the second extractor so that when the first extractor is in proximity to the tag the first and the second extractor can be activated for detaching the tag from the article. The operating member comprises a collector for automatically collecting at least one part of the detached tag.

The collector may further comprise at least one collection area where the at least one part of the tag is collected after being detached from the article. This prevents the operator from being able to interact with the separated parts if the tag. This improves the safety of the system since the risk of getting stuck by the needle in the tag is reduced.

The operating member may comprise a hollow inner member in which the first extractor is arranged and where the hollow inner member severs as a transportation groove for the tag to the collection area.

The hollow inner member may comprise a movable cover arranged to open and close an opening in the inner member so as to capture and transport the at least one part of the tag.

The operating member may be an operating arm.

The second extractor may be movable between an upper position and a lower position so as when moved downwards to the lower position the at least one part of the tag is collected in a further collection area.

Each one of the first extractor and the second extractor may comprise at least one magnet. The magnets may be configured to detach the tag by applying a magnetic force to the tag.

The detachment unit may further comprise a control unit being configured to control the operation of the operating member. The control unit may further be configured to control actuation of the first extractor and the second extractor. The control unit may be further configured to receive information related to a successful payment of the article, and to transmit a control signal to the operating member and/or the first and/or second extractor after receiving said payment information.

The detachment unit may comprise at least one verification sensor. The verification sensor may be an RFID-sensor, barcode-sensor and/or a NIR or VIS sensor. The verification sensor may be used to verify the identity of the article.

According to a second aspect, a method for removing a tag from an article by means of a detachment unit comprising an operating member having a first extractor is provided. The method comprises positioning a tag in a space between the first extractor and a second extractor, moving the operating member towards the second extractor such that the first and second extractors are in proximity to the tag, activating the first and second extractors such that the tag is detached from the article and collecting the at least one part of the detached tag.

According to a further aspect, an automatic checkout counter is provided. The automatic checkout counter comprises a classification device configured to identify article identities, a point-of-sale system for completing a transaction based on the articles identified by the classification device, and a detachment unit configured to remove a tag attached to an article once the transaction is completed.

The classification device may comprise at least one spectroscopy sensor and/or at least one bar-code reader and/or an RFID-sensor.

According to yet a further aspect, a method for detaching a tag in an automatic checkout counter is provided. The method comprises identifying an article identity, completing a transaction based on the articles being identified, and once the transaction is completed automatically activating a tag detachment unit for allowing the removal of a tag being attached to the article.

According to a further aspect, a method for detaching a tag in an automatic checkout counter is provided. The method comprises identify or verify an article identity, activating a tag detachment unit for allowing the removal of a tag being attached to said article based on the article being identified and once the tag is detached completing a transaction based on the articles being identified.

### BRIEF DESCRIPTION OF THE DRAWINGS

Embodiments of the invention will be described in the following; reference being made it the appended drawings which illustrate non-limiting examples of hoe the inventive concept can be reduced into practice.

FIG. 1 is a schematic view of a security tag;

FIG. 2 is an isometric view of a detachment unit according to an embodiment of the present invention;

FIGS. 3a-c are schematic side views of an operating member of a detachment unit according to an embodiment of the present invention;

FIGS. 4a-c are schematic side views of a detail of the detachment unit according to an embodiment of the present invention;

FIGS. 5a-b shows two schematic methods of how to operate a detachment unit according to an embodiment of the present invention;

FIG. 6 shows a top view of a checkout counter according to an embodiment of the present invention; and

FIG. 7 shows a schematic method of an automatic checkout counter according to an embodiment of the present invention.

### DETAILED DESCRIPTION OF EMBODIMENTS

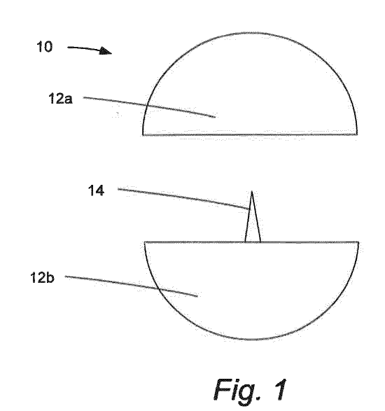

FIG. 1 shows en exemplified embodiment of a surveillance device in the form of a security tag 10, suitable for attachment on an article. In the embodiment shown in FIG. 1 the security tag includes two hard or rigid plastic tag bodies 12a, 12b which is arranged on each side of the article when attached thereto. The lower tag body 12b includes a sharp pin 14 that extends out to allow insertion of the pin into the material or fabric of the article. The pin 14 of the lower tag body 12b may be inserted through the article and into the upper tag body 12a to affix the tag 10 to the article. The upper tag body 12a may include a clutch or a clamp that captures the pin 14, thereby preventing unauthorized removal of the tag 10 from the article. It should be noted that the construction of tags could be the other way around, i.e. the pin may be arranged in the upper tag body instead of the lower tag body.

When the tag 10 is securely arranged, a customer can not detach the tag from the article by herself. The tag 10 may be opened, so that the pin 14, 34 may be removed form the article. This may for example be done by different kinds of system using magnetic forces or the like. Once such detachment system 100 is disclosed herein.

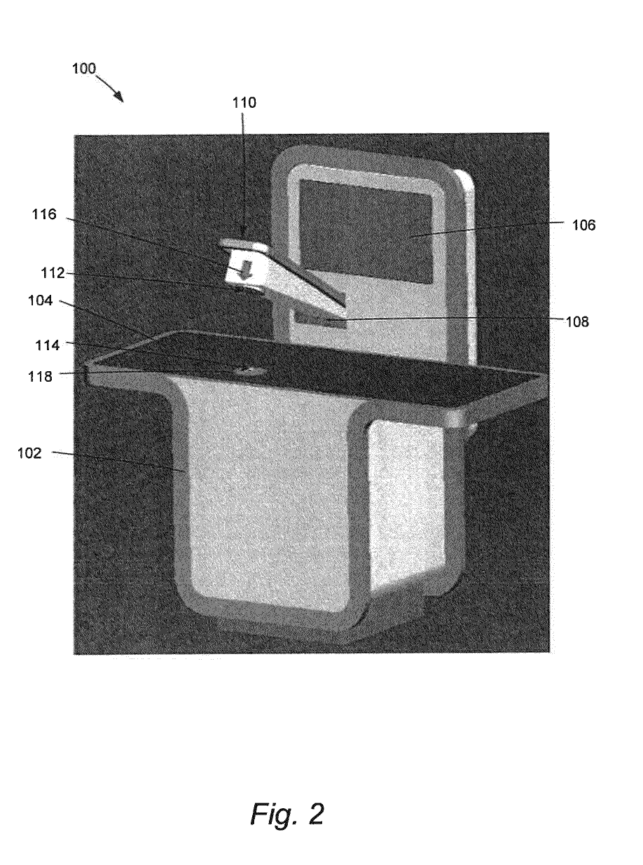

FIG. 2 shows a detachment unit 100 that is used to detach a security tag 10 from an article. The detachment unit 100 comprises a housing 102, having a surface 104 to which the article is to be placed and a display 106 for providing information to an operator handling the detachment unit 100. The housing 102 has an opening 108 which is intended to receive a movable operating member 110. The operating member 110 is arranged to be pressed by the operator in a downwards direction towards the surface 104 of the housing 102. When the operator releases the operating member 110, the member is automatically moved back into its idle position. This is preferably done by a counterweight.

In one embodiment as shown in FIG. 2 the operating member 110 is an operating arm that can be pushed downwards. However it should be noted that other kinds of operating members 110 may be used, such as a retractable hose that could be retracted downwards in a similar manner.

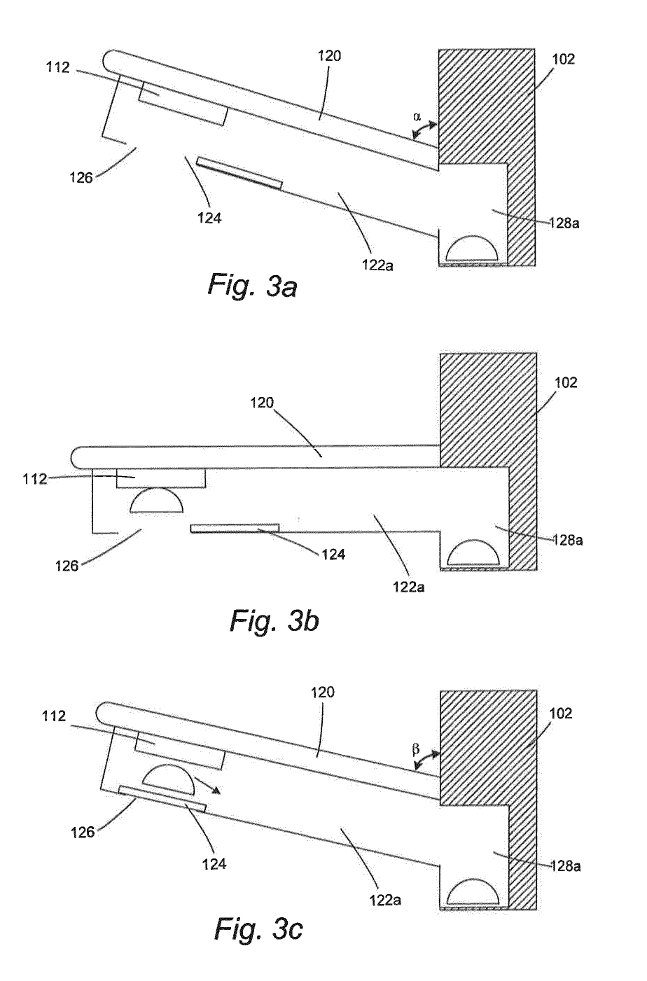

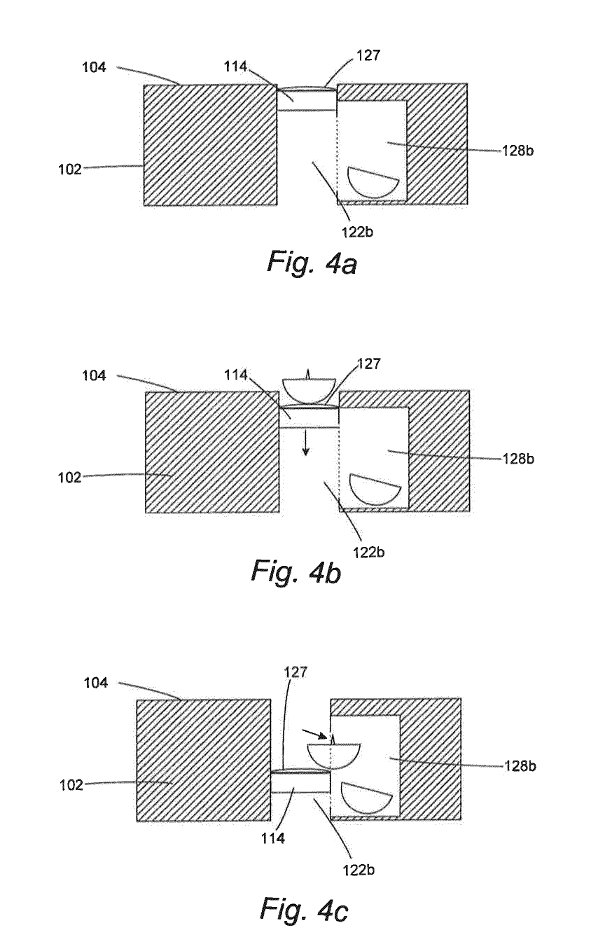

In order to separate the tag into two parts, and thus release the article from the tag, a first extractor 112 is arranged at the lose end of the operating member 110. When the operating member 110 is pressed down the first extractor 112 cooperates with a second extractor 114 arranged on or proximate to the surface 104 of the detachment unit 100. The first 112 and second 114 extractors are preferably arranged opposite to each other. The cooperation between the first extractor 112 and the second extractor 114 allows the security tag, arranged on the article, to be separated into two parts. Once the tag is detached, the parts of the tag are collected and transported by at least one collector 122a, 122b comprising collection areas 128a, 128b (as shown in FIG. 4a-c). Hence during the detachment process, the upper tag body is retracted by the first extractor 112 and transported and collected by a first collector 122a and the lower tag body is retracted by the second extractor 114 and transported and collected by a second collector 122b, as will be described more in detail in conjunction to FIGS. 3a-c and 4a-c. In this way, the operator is not able to interact with the separated parts of the tag. This has several benefits, one being that the risk of getting hurt by the sharp needle inside the tag is drastically reduced and another benefits lies in eliminating the risk of stealing the parts of the tag.

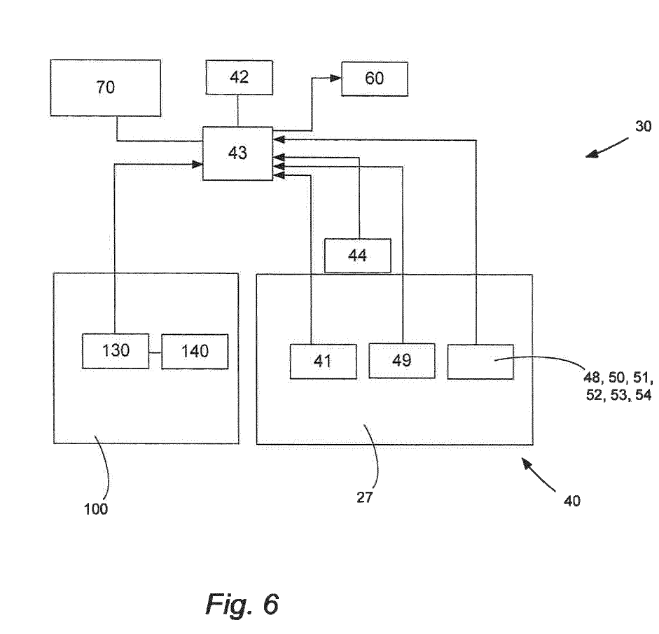

In one embodiment, the detachment unit 100 may only be used once it is activated. The activation of the detachment unit 100 may be done automatically by a system or manually by the operator depending on the arrangement of the detachment unit 100 in the store where the article is located. However, the following description will focus on when activation of the detachment unit 100 is achieved through communication with a greater system, e.g. a conveyor system having a point of sale (POS) terminal or a cash register as described further in reference to FIG. 6.

The detachment unit 100 as shown in FIG. 2 has a housing 102 that is a stand alone unit. However, in other embodiments the housing 102 of the detachment unit 100 could be part of a greater system, e.g. a conveyor system as described further in reference to FIG. 6. The height of the housing 102 may be adjustable to fit different needs of the user, such as being a wheelchair user or elderly using a walker.

In order to ease the understanding of how to maneuver the operating member 110 indication marks 116, 118 may be arranged on the detachment unit 100. In the embodiment shown in FIG. 2, a first indication mark 116 is arranged on the operating member 110 having the form of an arrow facing down towards the second extractor 114 on the surface 104, thus indicating the direction which the operator shall push the operating member 110. A second indication mark 118 is arranged on the surface 104 on or in conjunction with the second extractor 114 in the form of a dot, a cross or the like to illustrate where to place the tag. The indication marks 116, 118 may be light sources that are illuminated when the deactivation process is activated. In another embodiment, a light arranged in conjunction with the first extractor 112 is illuminating the second indication mark 118. It should be understood that the indications marks are optional and that several other types and arrangements of visual feedback could be used to facilitate understanding.

Another way to facilitate understanding on how to use the detachment unit 100 is by the display 106. The display 106 provides information to the operator on for example when the detachment unit 100 is activated and/or deactivated and how to use the detachment unit and if the article is placed in the correct spot. The display 106 may be an interactive display allowing the operator to gain further information regarding the process and may show information as images and/or as text.

In one embodiment the detachment unit 100 is further arranged with sound devices, such as a speaker, (not shown) which may provide audio feedback to the operator during use.

In one embodiment the indication marks 116, 118, the display 106 and/or the speaker are only switched on once the detachment unit 100 is activated.

The operating member 110 and the first extractor 112 will now be described more in detail with reference to FIG. 3a-c. As can be seen the operating member 110 comprises an outer member 120 and an inner member that acts as a collector 122a. The outer member 120 is the most visible for the operator, and is the part that the operator presses down in order to start the detachment process. The collector 122a is hollow and is arranged to act as protection and housing for the first extractor 112 arranged therein. The side of the collector 122a facing downwards towards the surface 104 has an opening 126 through which one part of the tag 10 may fit. The collector 122a comprises a movable cover 124 which when moved into a closed position covers the opening 126. The collector 122a further comprises a collection area 128a arranged to collect at least one part of the detached tag 10.

FIG. 3a shows the operating member 110 in its rest position, i.e. before the operator has pressed down the member towards the second extractor 114. The operating member 110 is angled in an angle α relative the housing 102. The angle α may be between 0-90°. In one embodiment the operating member 110 is held in a deactivated state until the detachment unit 100 is activated and the article is placed in a correct location. In this case, if an operator presses down the member 110 while being deactivated the detachment process does not start.

In one embodiment the operating member 110 is held in a secured locked position until the detachment unit 100 is activated and the article is placed in a correct location. The operating member 110 is held in its locked idle position by a switch (not shown). The switch is preferably a magnetic switch, although other types of switches are possible.

In FIG. 3b an operator has pressed down the operating member 110 into its operating position, which is substantially parallel to the surface 102, i.e. the operating member 110 has an angle of approximately 90° relative the housing. The first extractor 112, which in this embodiment comprises a magnet, has released the tag 10 from the article by an applied magnetic force. At least one of the tag bodies 10 is securely fastened to the magnet in the first extractor 114 due to the applied magnetic field. Once the at least one part of the tag 10 is in contact with the magnet of the first extractor 112, the tag body is lifted a predetermined distance in a direction away from the second extractor 114. The predetermined distance may be between 1-100 mm, and preferably around 15 mm. Once the operator lets go of the operating member 110 the member returns back towards its idle position. In one embodiment, the operating member 110 is held in its operating position until the extractors 112, 114 have detached the tag into two parts, hence the operator presses down the operating member 110 and then immediate releases the pressure while the operating member 110 stays in its operating position until the tags are detached.

When the operating member 110 has start to retract back to its position and is at an angle β as seen in FIG. 3c, the cover 124 is moved along the inner side of the operating member 110 in order to close the opening 126. The angle β may be between 0-90°. Once the cover 124 is moved to close the opening 136, the first extractor 112 is deactivated. Once the magnet in the first extractor 112 is deactivated, the magnetic field terminates and the tag body falls down from the magnet to the inner side of the operating member, i.e. into the collector 122a. Due to the inclination, the tag body then slides through the collector 122a towards the collection area 128a where it is stored. The collector 122 thus acts as a transportation groove for the tag body when the cover 124 is closing the opening 126.

Once the operating member 110 has retracted back to its idle position, with the inclination of a relative the housing as seen in FIG. 3a, the detachment process is finished and the operator may remove the article from the detachment unit 100.

Turning to FIG. 4a-c a detail view of the surface 104 of the housing 102 and the second extractor 114 is shown. In this embodiment, a protective padding 127 is arranged on top of the second extractor 114 to protect the second extractor 114 from surrounding dirt as well as preventing operators to touch the extractor 114. A collector 122b is arranged in the surrounding housing to collect at least one of the tag bodies that have been detached into a collection area 128b.

FIG. 4a shows the second extractor 114 in an idle state, waiting for an operator to initiate the detachment process. The second extractor 114 is arranged in a height that is slightly lower than the surrounding surface area. However, as understood by a skilled person, the second extractor 114 could be aligned with the surface area or be arranged at a height slightly above the surface area. The second extractor 114 is movable between an upper position and a lower position through the collector 122b, which is a groove arranged along the vertical length of the housing arranged to collect the at least one part of the detached tag 10.

FIG. 4b shows when the process starts, i.e. when an operator has lowered the operating handle 110 and thus activated the first and second extractors 112, 114. The second extractor 114, which in this embodiment comprises a magnet, has released the tag 10 from the article by an applied magnetic force. At least one of the tag bodies 10 is securely fastened to the magnet in the second extractor 114 due to the applied magnetic field. The tag body is retracted a predetermined distance in a direction downwards the collector 122b by a downward movement of the magnet. The predetermined distance may be between 1-100 mm, and preferably around 40 mm.

FIG. 4c shows the end of the process, where the magnet of the second extractor 114 has reached its lower position in the collector 122b and the tag body 10 is ejected into the second collection area 128b. The tag may be ejected in several ways, for example by a sideway force caused by high pressured air, a magnetic field or a mechanical ejection. In one embodiment the second extractor 114 is slightly tilted, so that the tag will start sliding towards the collection area 128b due to the force applied when the second extractor 114 is retracted downwards. In another embodiment the second extractor 114 is movable such that it has an inclined angle facing the collection area 128b once the second extractor 114 is reaching its lower position. In yet another embodiment, the collection area 128b is arranged with a magnet (not shown) which attracts the part of the tag into the collection area 128b once it is activated.

Once the process is ended and the parts are collected, the second extractor 114 is moved up back into its idle position.

The collection areas 128a, 128b are preferably of a size that can contain a plurality of tag bodies and may for example be emptied by authorized personnel after closing or before opening the store. The collection areas 128a, 128b may be combined with a sorting station, which sorts the needle from the tag body. The first and second collection areas 128a, 128b and the possible sorting station are configured to work the same way. This allows the operator to place the article with the tag in any direction, not having to worry about having the upper tag body facing up and the lower tag body facing down.

Although only two collection areas 128a, 128b are shown in the embodiments of FIG. 3-4, it should be noted that more collection areas could be added. For a store with a lot of costumers each day, it may be beneficial to have four collection areas in order to have place for all the detached tag bodies.

As already been mentioned, each of the first and second extractors 112, 114 may comprise magnets. The magnets may be permanent magnets and/or electromagnet, where electromagnets have the benefit of being able to control the force applied. The size of the magnets may depend on the size of the tags 10. For example, tag 10 of a greater size requires a bigger sized magnet in order to be able to separate the parts from the tag.

As mentioned above, the side of the extractors 112, 114 facing towards the article may be covered by a protective padding 127. In one embodiment as shown in FIG. 4a-c, only the second extractor 114 is arranged with a protective padding 127. However, it should be noted that the protective padding also may be arranged in conjunction to the first extractor 112. The protective padding 127 prohibits the operator to be able to touch the second extractor 114.

The extractors 112, 114 or part of the extractors 112, 114, such as the padding(s), may be easily exchangeable by authorized personnel in the store. This allows for great flexibility. For example, it is easy to replace one of the extractors 112, 114 due to malfunction. Furthermore, if the store having the detachment unit 100 installed wants to change from one type of security tags into another type, it is possible to easily adjust and/or replace the paddings of the extractors 112, 114 to fit the new tags. Different kinds of security tags may be of different shapes and it is thus beneficial not having to purchase a new detachment unit 100 in order to fit a new tag shape. Beneficially, the materials of the padding are easy to clean since it is the contact area against the tags. The padding can either be cleaned when arranged at the extractors 112, 114 or when dissembled by authorized personnel in the store.

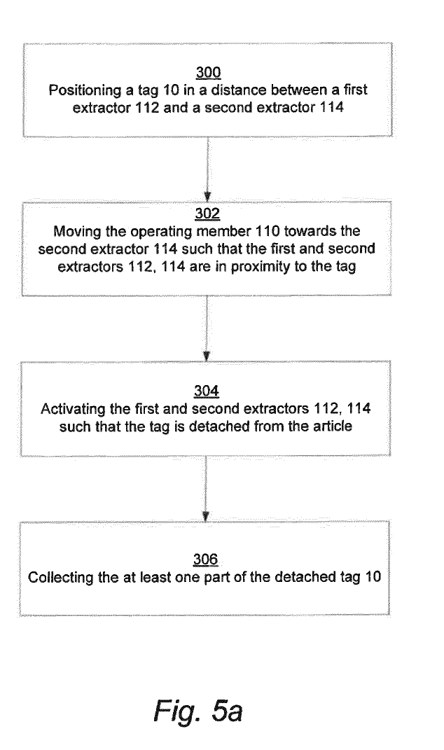

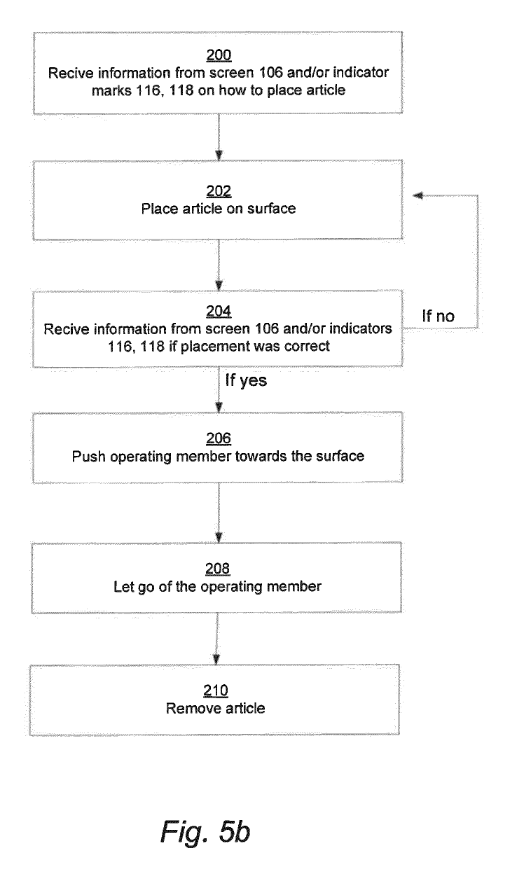

A method of a detachment unit 100 for removing a tag 10 from an article is shown in FIG. 5a. The method comprises positioning 300 a tag 10 in a distance between the first extractor 112 and a second extractor 114. The next step is moving the operating member towards the second extractor such that the first and second extractors 112, 114 are in proximity to the tag, 302. Once the first and second extractors 112, 114 are in proximity to the tag the detachment unit 100 activates the first and second extractors 112, 114 such that the tag is detached from the article 304. Once the tag is detached from the article, the at least one part of the detached tag 10 are collected, 306.

A method on how to operate an active detachment unit 100 is shown in FIG. 5b. The operator places the article that is to be detached from its security tag on the surface 104 of the detachment unit 100. In order to put the article in the correct position, the operator looks at the screen for information and/or looks at the second indication mark 118 arranged to light up the suitable area 200. Once the article is placed 202, the display may show responsive information to if the article is placed correctly or not, e.g. by illuminating the indication marks 116, 118 in green or showing an “OK TO START” sign on the display 106 when the article is placed correctly or by illuminating the indication marks 116, 118 in reed or showing an “NOT CORRECT” sign on the display 106 when the article is placed on the wrong spot 204. Once the article is placed in is correct position the operator pushes 206 the operating member 110 towards the surface 106 of the detachment unit 100. The extraction of the security tag begins once the operating member 110 is in its operating position, i.e. when the operating member 110 is as close to the surface as possible. The operator releases 208 the operating member 110, which then automatically retracts into its idle position. The tag and the parts of the tag are now automatically removed from the article and the operator may remove the article 210 from the detachment unit 100. If many items were bought having security tags, the detachment process is repeated until all articles are detached from its respective tag.

The detachment unit 100 may have several features in order to prevent potential misuse. In one embodiment, the detachment unit 100 is able to recognize if there is material between the security tag and the second extractor 114 and thus alarm the operator that the article and tag is incorrectly placed on the surface 104. This may be done by a sensor, and preferably a structure sensor or a 3D sensor.

In one embodiment, the detachment unit 100 is able to recognize a failed separation of the security tag due to having a material between the security tag and the second extractor 114 during the detachment process and thus alarm authorized personnel to help with the process. This may be achieved by having a separation sensor that register if the detachment process is slower than usual and/or that senses if the fabric of the article is drawn into the second extractor 114. It is also possible to have a separation sensor that registers if the lower tag body is retracted into its collection area, and if not the detachment process has not been succeeded and the detachment unit 100 goes into an error mode awaiting assistant from personnel. Furthermore, if the lower or upper tag body does not separate from each other the process is stopped and put into an error mode. The separation sensors may for example be accelerometer based sensors, pressure sensors or displacement sensors.

Although the embodiment(s) in the description herein focuses on a first extractor 112 and a second extractor 114 comprising magnets, where the magnets are configured to detach the tag 10 by applying a magnetic force to the tag 10, it should be noted that the extractors 112, 114 may comprise other means to detach the tag from an article. In one embodiment the first and second extractor 112, 114 uses vacuum in order to detach and collect the tag. In yet another embodiment the tag is arranged with at least two stripes of hook-and-loop fastener, such as Velcro, arranged at each side of the tag. The tag is detached by using the first and second extractor 112, 114 which each comprises at least one stripe of hook-and-loop fastener.

The following description will focus on having a detachment unit 100 as above arranged in conjunction with a greater system, such as a conveyor system having a point of sale (POS) terminal or a cash register. This will now be described in reference to FIG. 6 showing an automatic checkout counter 30 comprising a classification device 40 on which the article are automatically identified arranged on a counter 27 on which articles may be placed by a customer, a point-of-sale system 70 for completing a transaction based on the articles identified by the classification device and a detachment unit 100 configured to remove a tag 10 attached to an article once the transaction is completed.

According to an embodiment, the classification device 40 comprises a bar code reader 49 for identifying the article, being incorporated in the counter 27, a memory unit 42 comprising information of one or more articles, a processor 43 connected to the memory unit 42 and to the bar code reader 49, and at least one spectroscopy sensor 44, from here on denoted as a NIR or a VIS sensor 44 depending on the associated wavelength interval, connected to the processor 43. The NIR and/or VIS sensor may be arranged at a lateral end of the counter 27 and is facing towards the articles passing.

The counter 27, including the barcode reader 49, is configured to identify the article and transmit such information to the processor 43. The bar code reading system 49 may comprise one or more readers. One reader 49 may be arranged at a lateral end of the counter 27 thus scanning inwards towards the articles passing. Further, additional bar code readers for creating a complete coverage of the articles may be provided. Hence, an upper, lower, left, right, front, and back side of the article could thus be scanned by the readers. In a particular embodiment, a bar code reader is positioned under a slit in the counter 27 and scanning upwards, such that a bar code becomes visible when it is arranged on the counter 27.

The NIR or VIS sensor 44 detects a reflection spectrum from an article, whereby the processor 43 is configured to match the measured reflection spectrum with a database of reference spectrums, whereby each reference spectrum is associated with a unique article identity. Hence, different articles will provide a unique reflection spectrum whereby an accurate identification may be achieved for articles not carrying a bar code.

The NIR or VIS sensor 44 must thus be capable of detecting the reflection spectrum for a wide variety of articles having different dimensions. For example, such articles include both small packages of socks as well as larger articles, such as a jacket, a pair of jeans, etc. In order to be able to measure such reference spectrum in a reliable manner the NIR or VIS sensor 44 is preferably arranged on a support, which support is configured to be moveable such that the NIR or VIS sensor 44 may be directed towards the article passing. Hence, a first sensor, such as a camera, is configured to provide information corresponding to the dimensions of the article. The information is transmitted to the processor 43, which then calculates a correct angle of the NIR or VIS sensor 44, i.e. an angle relative the horizontal plane. If the article is very small, such as the pair of socks, the NIR or VIS sensor 44 is directed towards the counter 27, i.e. downwards. Should the article be large, such as a pair of jeans, the NIR or VIS sensor 44 will be directed upwards.

As already discussed briefly above, the memory unit 42 comprises one or more digital signatures created by the at least one spectroscopy sensor 44, wherein each one of said signatures is associated to a corresponding article identity. A benefit of the classification device 40 is that the checkout counter 30 automatically may identify all sorts of articles without any need for the customer to identify the article before the checkout counter, e.g. with a barcode. The NIR or VIS sensor 44 is particularly valuable for identifying fruit and vegetables, and certain types of bulk articles, since these articles have previously required the customer to mark the article with a bar code due to the fact that sensors using cameras and image processing have not been able to determine the article identity accurately enough.

Having both NIR or VIS sensor 44 and a barcode reader 49 has the advantage of preventing fraud, in case a customer tries to replace the barcode of an expensive article with a barcode of a cheap article. For example, should a barcode of a cheap pair of gloves be placed on an expensive suit, the NIR or VIS sensor 44 may in fact be used to compare the reflection spectrum of the article with stored reference spectrum stored in the memory 42. Hence, such fraud will be detected and an alarm may be triggered.

The identity of the article may be determined by matching a measured signature to a database comprising properties of a plurality of articles. The database may be stored in the memory unit 42 and examples of properties are reflection spectrum, weight, size, color, shape, contour, barcode patterns and/or text and/or figure and/or pattern.

A display unit 60 may be connected to the processor 43 for displaying at least one article identity. The display unit 60 is preferably arranged for use by a customer for approving the displayed information. If the first NIR or VIS sensor 44 identifies the article, an image or a text is shown in the display unit 60 and if the user finds the displayed information matching the article which presently is in the checkout counter 30 the customer may approve the identity by manual input. Further information may be displayed, e.g. weight and price, wherein the user may approve the displayed information if it is correct.

According to one embodiment the checkout counter 30 may, as a compliment to the first NIR or VIS sensor 44 and the weight sensor 41, be provided with one or several further sensors which, if used according to the invention, brings out the advantage of increasing the security when identifying the article, but with a minimum use of resources and time and energy. It should be mentioned here that an article should preferably be identified in less than one second for an automated checkout counter to be considered as user friendly by the customers.

The classification device 40 may further use a further sensor being selected from the group consisting of: an additional spectroscopy sensor (not shown), a RFID sensor 54, a contour sensor 48, a weight sensor 41, a symbol reading sensor 50, a color texture sensor 51, a color histogram sensor 52, or an object sensor 53. The contour sensor 48, the symbol reading sensor 50, the color texture sensor 51, the color histogram sensor 52, and the object sensor 53 may all be implemented by one or several cameras which are connected to the processor 43, which processor 43 is configured to provide a specific image computing algorithm for extracting the required information from the image.

The weight sensor 41 is a scale configured to detect the weight of the article and transmit such information to the processor 43. This allows providing a correct pricing for such articles which are priced based on the weight.

The detachment unit 100 may further comprise at least one verification sensor 140. The verification sensor 140 may be used to identify and/or verify the identity of the article that is to be detached from its tag. The sensor(s) may be an RFID-sensor, barcode-sensor and/or a NIR or VIS sensor. The detachment unit 100 may further comprise a control system 130 configured to control the operation of the detachment unit 100 and/or the operating member 110 and/or the first and second extractors 112, 114. As seen in FIG. 6 the control unit 130 is in direct communication with the sensor 140, however in other embodiments the sensor 140 may be in direct control with the processor 43 of the classification device 40.

In one embodiment, once all the articles of the costumer are correctly identified by the classification device 40 the processor 43 transmits a transaction signal to the point-of-sale system 70 to allow the costumer to finish the payment transaction. Once a successful payment is achieved, a control signal is sent to the control unit 130 in the detachment unit 100. In one embodiment, the control signal is sent directly from the point-of-sale system 70 to the control unit 130. In another embodiment, the signal is sent from the point-of-sale system 70 to the processor 43 of the classification device 40 and then sent from the processor 43 to the control unit 130. The point-of-sale system 70 and the control unit 130 thus have a direct or indirect communication.

The control unit 130 of the detachment unit 100 is configured to control the operation of the operating member 110 of the detachment unit and/or to control the actuation of the first extractor 112 and the second extractor 114. The control unit 130 is further configured to receive information related to a successful payment of the article and to transmit a control signal to the operating member 110 and/or the first and/or second extractor 112, 114 after receiving the payment information. When an activation signal is sent to control the operation of the operating member 110 of the detachment unit and/or to control the actuation of the first extractor 112 and the second extractor 114 the detachment unit 100 is activated and put in an active state.

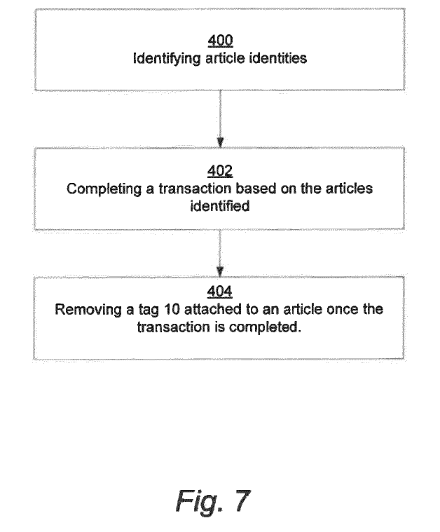

In one embodiment, the detachment unit 100 is activated based on receiving information related to a successful payment of the article. FIG. 7 illustrates a method of an automatic checkout counter described above. The method comprises identifying article identities 400 by the classification device 40. The classification device 40 may use VIS or NIS sensors 44 and/or bar-code reader(s) 49 and/or RFID readers to identify the article. Once all the articles are identified a point-of-sale system 70 is activated to complete a transaction based on the articles identified 402. Once the transaction is validly completed, the detachment device removes the tag 10 attached to the article 404.

In one embodiment, the detachment unit 100 and/or the first and second extractors 112, 114 are activated based on receiving information related to a successful verification of the articles identity. The classification device 40 identifies the article and the point-of-sale system 70 is activated, and once the transaction is validly completed the operator places the article on the detachment unit 100. The detachment unit 100 uses the verification sensor 140 to verify that the article is in fact the paid article. This may be verified by communication between the verification sensor 140 and the processor 43 of the classification device 40. It may also be verified by communication between the verification sensor 140 and the processor 43 via the control unit 130 of the detachment device 100. Once the sensor(s) has verified the identity of the article the detachment device may remove the tag 10 from the article.

In one embodiment, the detachment unit 100 is activated based on receiving information related to a successful payment of the article as well as receiving information related if the article is identified having a security tag. First, the classification device 40 indentifies the articles to be purchased, and if an article is identified having a security tag, this information is sent from the processor 43 to the controller 130 in the detachment unit 100. The control unit 130 puts the detachment unit 100 in an active passive state, making the unit ready to be operated as soon as the payment transaction is terminated. When the payment transaction is validly finished, the payment terminal 70 sends an activation signal to the control unit 130 of the detachment unit 100, making the detachment unit 100 activated and ready to be operated.

In yet another embodiment, the detachment unit 100 is activated once an article is identified to have a security tag. The classification device 40 indentifies the articles to be purchased, and if an article is identified having a security tag, this information is sent to the control unit 130 of the detachment unit 100. This information is transmitted from the processor 43 in the classification device 40 to a control unit 130. Once the information is received, the control unit 130 puts the detachment unit 100 in an active state, making the unit ready to be operated.

In one embodiment, once all the articles of the costumer are correctly identified by the classification device 40 the processor 43 transmits a removal signal to the control unit 130 in the detachment unit 100. The control unit 130 of the detachment unit 100 is configured to control the operation of the operating member 110 of the detachment unit and/or to control the actuation of the first extractor 112 and the second extractor 114. The control unit 130 is further configured to receive information related to a verification of an article to transmit a control signal to the operating member 110 and/or the first and/or second extractor 112, 114 after receiving the verification signal. The detachment unit 100 and/or the first and second extractors 112, 114 are thus activated based on receiving information related to a successful verification of the articles identity. The classification device 40 identifies the article and the operator places the article on the detachment unit 100. The detachment unit 100 uses the verification sensor 140 to verify that the article is in fact the classified article. This may be verified by communication between the verification sensor 140 and the processor 43 of the classification device 40. It may also be verified by communication between the verification sensor 140 and the processor 43 via the control unit 130 of the detachment device 100. Once the sensor(s) has verified the identity of the article the detachment device may remove the tag 10 from the article. Once the tag is removed from the article the control unit 130 of the detachment unit 100 transmits a transaction signal to the point-of-sale system 70 to initiate payment. Hence, in this embodiment the point-of-sale system 70 is activated based on a verification signal from the detachment unit 100.

Although several embodiments has been described on how to activate the detachment unit 100 through the use of a greater system it should be noted that the above activation methods could be combined into one single method. Hence the detachment unit 100 may be activated based on a combination of signals receiving information related to a successful payment of the article, receiving information related if the article is identified having a security tag and based on receiving information related to a successful verification of the articles identity. Furthermore, the first and second extractors 112, 114 may be activated based on a combination of signals receiving information related to a successful payment of the article, receiving information related if the article is identified having a security tag and based on receiving information related to a successful verification of the articles identity.

It should be appreciated that even though numerous characteristics and advantages of the present invention have been set forth in the foregoing description, together with details of the structure and function of the invention, the description is only illustrative and changes may be made in detail, especially in matters of shape, size and arrangement of parts within the scope of the invention to the full extent indicated by the appended claims.

1-16. (canceled)

17. A detachment unit for removing a tag from an article comprising:
an operating member comprising a first extractor; and
a second extractor arranged at a distance from said operating member such that the tag can be positioned between the first extractor and the second extractor;
wherein the operating member is movable such that the first extractor moves towards and away from the second extractor so that when the first extractor is in proximity to the tag the first and the second extractor can be activated for detaching the tag from the article, wherein the operating member comprises a collector for automatically collecting at least one part of the detached tag.

18. The detachment unit according to claim 17, wherein the collector further comprises at least one collection area where the at least one part of the tag is collected after being detached from the article.

19. The detachment unit according to claim 18, wherein the operating member comprises a hollow inner member in which the first extractor is arranged and where the hollow inner member severs as a transportation groove for the tag to the collection area.

20. The detachment unit according to claim 19, wherein the hollow inner member comprises a movable cover arranged to open and close an opening in the inner member so as to capture and transport the at least one part of the tag.

21. The detachment unit according to claim 18, wherein the second extractor is movable between an upper position and a lower position so as when moved downwards to the lower position the at least one part of the tag is collected in a further collection area.

22. The detachment unit according to claim 17, wherein each one of the first extractor and the second extractor comprises at least one magnet.

23. The detachment unit according to claim 22, wherein the magnets are configured to detach the tag by applying a magnetic force to the tag.

24. The detachment unit according to claim 17, further comprising a control unit being configured to control the operation of the operating member.

25. The detachment unit according to claim 24, wherein the control unit is further configured to control actuation of the first extractor and the second extractor.

26. The detachment unit according to claim 24, wherein the control unit is further configured to receive information related to a successful payment of the article, and to transmit a control signal to the operating member and/or the first and/or second extractor after receiving said payment information.

27. A method for removing a tag from an article by means of a detachment unit comprising an operating member having a first extractor, the method comprising:
positioning a tag in a space between the first extractor and a second extractor;
moving the operating member towards the second extractor such that the first and second extractors are in proximity to the tag;
activating the first and second extractors such that the tag is detached from the article; and
collecting the at least one part of the detached tag.

28. An automatic checkout counter, comprising a classification device configured to identify article identities, a point-of-sale system for completing a transaction based on the articles identified by the classification device, and a detachment unit configured to remove a tag attached to an article once the transaction is completed.

29. (canceled)

30. The checkout counter according to claim 28, wherein said classification device comprises at least one spectroscopy sensor.

31. A method for detaching a tag in an automatic checkout counter, the method comprising:
identifying an article identity;
completing a transaction based on the article being identified; and
once the transaction is completed automatically activating a tag detachment unit for allowing the removal of a tag being attached to said article.
